(19) United States
(12) Patent Application Publication
(10) Pub. No.: US 2026/0051308 A1
(43) Pub. Date: Feb. 19, 2026

(54) MULTI-FUNCTION BIMORPH MICROELECTROMECHANICAL SYSTEMS INTEGRATION (MEMS) FOR ANALOG TUNABILITY IN METASURFACES

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/809,012

(22) Filed: Aug. 19, 2024

(51) Int. Cl. G10K 11/16

(52) U.S. Cl. CPC G10K 11/16; H04R 2201/003

(57) ABSTRACT

The technology described herein is directed towards a metasurface arranged with unit cells for narrowband sound absorption, in which the unit cells are based on Helmholtz resonators that can have their resonant frequencies adjusted via MEMS actuators. A sound absorbing unit-cell is designed and constructed based on a general resonance frequency, and includes a neck portion and air chamber dimensioned to resonate close to the desired resonance frequency and thereby inverse phase cancel corresponding narrowband frequencies of incoming sound waves. A bimorph MEMS actuator and/or moveable part in the resonators, controlled by a controller, facilitates changing of the airflow the unit cells to adjust the resonant frequencies thereof, to cancel acoustic waves of different frequencies corresponding to noise, which can change over time. The unit cells can be distributed as part of a metasurface, which can be positioned proximate to a noise source to phase cancel the noise.

### BACKGROUND

Acoustic absorbers are specialized materials or structures designed to mitigate the effects of sound reflections, echoes, and reverberations in various environments. These absorbers function by capturing sound waves and converting their energy into heat, effectively reducing the intensity of the sound waves and preventing them from bouncing off surfaces and causing unwanted sound reflections. They are typically engineered using porous materials with intricate structures that allow sound waves to penetrate deep into the material, where the acoustic energy is dissipated as thermal energy through friction and air resistance.

Existing acoustic absorbers come in various forms, including foam panels, fabric-wrapped panels, diffusers, bass traps, and more. One of the problems with existing acoustic absorbers is that they are not desirable in certain heat-sensitive environments. For example, servers generate a lot of heat and thus are designed with fans to cool dissipate the heat; however, fans can generate a lot of annoying noise. Using existing acoustic absorbers to absorb server noise reduces the noise, but can significantly reduce dissipation of the heat generated by servers, which can result in high heat levels that can reduce server performance and possibly cause a server to shut down to avoid damage from overheating.

### BRIEF DESCRIPTION OF THE DRAWINGS

The technology described herein is illustrated by way of example and not limited in the accompanying figures in which like reference numerals indicate similar elements and in which:

FIG. 1A is a block diagram showing an example system for implementing a metasurface with bimorph microelectromechanical systems (MEMS) actuators in resonating unit cells for noise cancellation by phase canceling a narrowband frequency in acoustic waves, in accordance with various example embodiments and implementations of the subject disclosure.

FIG. 1B is a representation of an example metasurface deployed for noise cancellation, including a resonator with a bimorph MEMS actuator for varying the resonance frequency, in accordance with various example embodiments and implementations of the subject disclosure.

FIG. 2A is a two-dimensional side view representation of example unit-cells, including one enlarged unit cell showing various dimensions that determine, in part, the unit cell's resonance frequency, in accordance with various example embodiments and implementations of the subject disclosure.

FIG. 2B is a graphical representation of resulting absorption coefficient values of the unit-cell(s) of FIG. 2A over a range of frequencies, including a very high absorption coefficient value at the designed frequency 1310 Hz, in accordance with various example embodiments and implementations of the subject disclosure.

FIGS. 3 and 4 are side view representations of an example noise canceling Helmholtz resonator that includes a bimorph MEMS actuator for varying the resonance frequency by changing the airflow in the resonator's chamber, in accordance with various example embodiments and implementations of the subject disclosure.

FIGS. 5 and 6 are side view representations of an example noise canceling Helmholtz resonator that includes a bimorph MEMS actuator for varying the resonance frequency by changing the airflow in the resonator's chamber by moving a moveable part within the resonator's chamber, in accordance with various example embodiments and implementations of the subject disclosure.

FIG. 7 is a side view representation of an example noise canceling Helmholtz resonator that includes a bimorph MEMS actuator for varying the resonance frequency by changing the airflow in the resonator's neck port, in accordance with various example embodiments and implementations of the subject disclosure.

FIG. 8 is a side view representation of an example noise canceling Helmholtz resonator that includes a MEMS actuator for varying the resonance frequency by changing airflow in the resonator's chamber based on sensor feedback to a controller, in accordance with various example embodiments and implementations of the subject disclosure.

FIGS. 9A and 9B are side view representations of an example bimorph MEMS-based actuator highlighting fabrication before and after removal of a sacrificial layer, respectively, in accordance with various example embodiments and implementations of the subject disclosure.

FIG. 9C is a side view representation of an example MEMS-based actuator showing an example in which a cantilever is shown as bent straighter as a result of joule heating, in accordance with various example embodiments and implementations of the subject disclosure.

FIG. 10 is a three-dimensional representation of an example sound absorbing metasurface showing an enlarged view of an example unit cell with airflow changing capabilities, in accordance with various example embodiments and implementations of the subject disclosure.

FIG. 11 is a representation of an example portion of a sound absorbing metasurface showing an enlarged view of two of a metasurface's adjacent, variable airflow unit cells positioned to phase cancel a narrowband frequency within incoming acoustic waves from a server, in accordance with various example embodiments and implementations of the subject disclosure.

FIG. 12 is a representation of an example portion of a sound absorbing metasurface showing an enlarged view of two of a metasurface's adjacent, variable airflow unit cells positioned to phase cancel a narrowband frequency within incoming acoustic waves from a rack of servers, in accordance with various example embodiments and implementations of the subject disclosure.

FIG. 13 is a three-dimensional, perspective representation of an example sound absorbing metasurface composed of unit cells for wrapping around a rack of servers to reduce noise emanating from the servers, in accordance with various example embodiments and implementations of the subject disclosure.

FIG. 14 is a flow diagram showing example operations related to controlling a MEMS device to adjust variable airflow of a Helmholtz resonator unit cell, to resonate the Helmholtz resonator unit cell to cancel acoustic wave noise, in accordance with various example embodiments and implementations of the subject disclosure.

### DETAILED DESCRIPTION

Various embodiments and implementations of the technology described herein are generally directed towards a sound absorbing device based on inverted phase cancellation, and more particularly towards Helmholtz resonators with variable airflow capabilities, and thus adjustable resonant frequencies, as adjusted by a microelectromechanical systems (MEMS) device. The MEMS device can be implemented as a bimorph material cantilever, for example.

The technology described herein facilitates the design and implementation of such unit cells into metasurfaces that can be configured and positioned to efficiently absorb and dissipate sound waves of a specific frequency. Significantly, the use of metasurfaces as described herein do not increase the heat levels of computing devices substantially compared to existing technologies for sound absorption that do not facilitate ventilation/do not dissipate the heat very well. The specific frequency can be of any frequency/narrowband frequency range over a broad range of audible frequencies, or even subsonic (below 20 Hz)/supersonic frequencies (up to about 20,000 Hz).

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

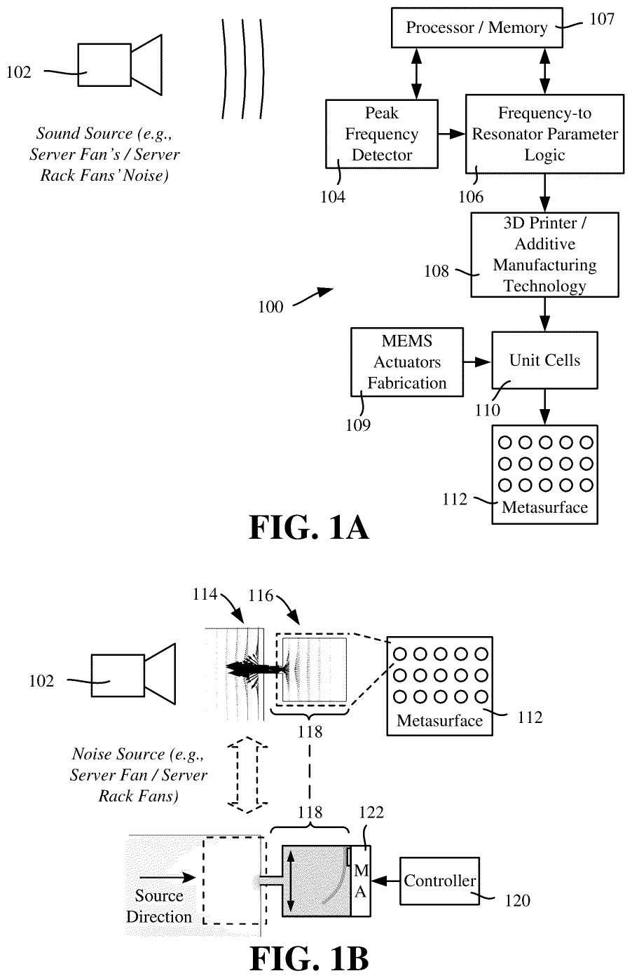

FIG. 1A shows a generalized block diagram of an example system 100 including a sound source 102 such as server fan/fans of a rack of servers that generate undesirable noise including at a frequency that is to be absorbed based on the technology described herein. A frequency measurement tool can be used as a peak frequency detector 104 or the like to determine which approximate narrowband frequency to cancel as described herein. As will be seen, the frequency itself is absorbed extremely efficiently by the technology described herein, with a narrow band of nearby frequencies also reduced to a lesser, but still desirable, extent.

Once the general frequency to cancel is determined, frequency-to resonator parameter logic 106 can be used to determine the parameters of unit cells that can inverse phase cancel that frequency. The parts of the unit cell can be constructed with 3D printer/additive manufacturing technology 108. The MEMS device, described herein, can be 3D printed, or can be separately fabricated (block 109), and, for example, can be incorporated into the unit cell, or positioned at a location that can change airflow in the unit cell. As a more particular example, consider a Helmholtz resonator cavity (e.g., the chamber portion) that includes a bimorph MEMS device that can be curved/angled. The MEMS device can be controlled to change its angle/curvature to change the airflow within the unit cell's chamber, thereby establishing the resonant frequency of the Helmholtz resonator.

The unit cells are based on the principles of Helmholtz resonators, which are acoustic cavities with a small neck port or opening that are highly effective at absorbing specific frequencies via resonance. For example, the resonant frequency (f_{resonance}) of a classical Helmholtz resonator with respect to frequencies in the audible range is determined by:

$${f}_{resonance} = \frac{c}{2 π} \sqrt{\frac{S}{{L}_{p} V}}$$

where c is the speed of sound, S is the neck port cross-sectional area, Lₚ=L_{neck}+1.7r_{neck} (for a cylindrical neck port) and V is the unit cell's cavity chamber's volume.

The unit cells, each represented as a small circle in FIGS. 1A and 1B, are incorporated into a metasurface 112, which can then be positioned to cancel the noise source at the determined frequency. In one implementation, the metasurface 112 contains an array of the unit cell resonator units arranged in a two-dimensional pattern. For absorbing a server's fan noise, for example, the metasurface 112 can be positioned proximate to the server's location, or even wrapped around at least part of the server's housing. The same metasurface noise-cancellation concept can be extended to a rack of servers via appropriately-sized (e.g., larger) and/or more metasurfaces.

As generally represented in FIG. 1B, when incident sound waves (block 114) interact with the metasurface 112, the variable Helmholtz resonators within the array selectively absorb the corresponding frequencies via inverse phase cancellation (represented by vectors in blocks 114 and 116). As sound waves enter the resonators (e.g., the resonator 118) through the neck port, they create pressure fluctuations within the cavities. By engineering the geometrical parameters of the cavity/air chamber, and then adjusting the cavity airflow as needed (via a controller and MEMS actuator (MA) 122) as described herein, the resulting resonance frequency of the unit cell creates a π phase shift reflected wave with respect to the incident wave as shown in FIG. 1B, where the two sets of waves with opposite phase cancel, effectively absorbing the frequency. This is highlighted via the air velocity vector plot showing the direction of the reflected wave with π phase shift in the upper portion of FIG. 1B. In addition, these pressure fluctuations also cause the air inside the cavities to oscillate, effectively converting acoustic energy into kinetic energy. This kinetic energy is then dissipated as heat through viscous losses in the narrow neck of the resonators, however the heat dissipation is appreciably better relative to traditional sound absorbers and does not significantly affect thermal performance of a server.

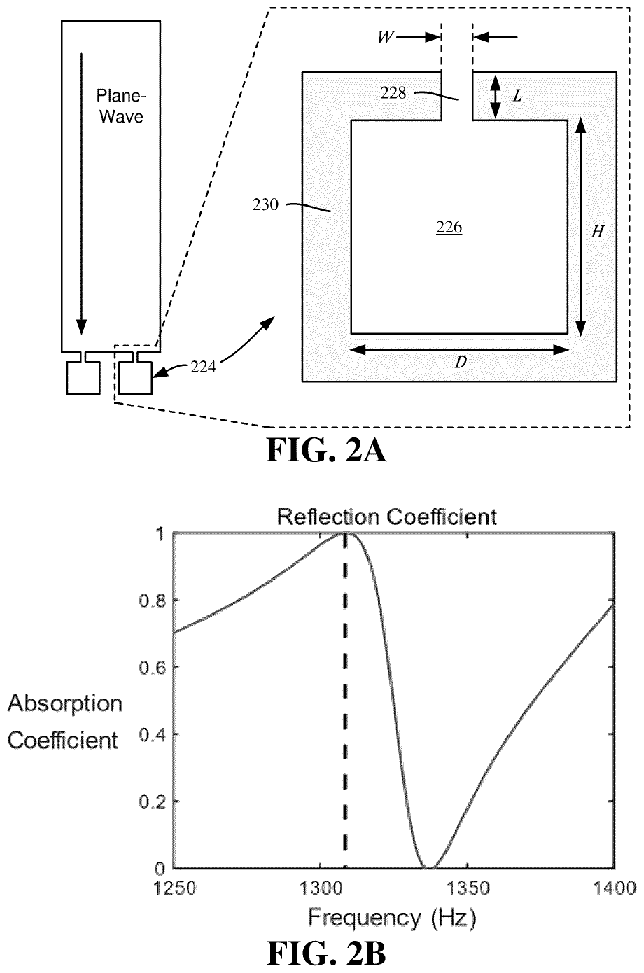

As generally represented in FIG. 2A, each unit cell 224 comprises a cavity, or air chamber 226, often with a neck port 228 that exposes the air chamber to the air/incoming sound waves, with dimensions engineered to target a particular frequency or a narrowband range of frequencies of interest. The dimensions of the air chamber 226 and neck port 228 are designed based on generally desired narrow band of acoustic frequencies to cancel, allowing the unit cells of the metasurface 112 (FIG. 1) to resonate when exposed to sound waves of those frequencies. When constructed, the air chamber 226 and neck port 228, which are hollow to contain air, and have one or more variable dimensions as described herein, are enclosed in a supporting structure 230 through which the neck port 228 extends to couple the chamber to the air propagating the sound wave.

FIG. 2A illustrates the unit cell's dimensions, which are “variable” during initial design before fabrication, and then once constructed and deployed, are controllably variable via MEMS adjustment (not explicitly shown in FIG. 2A) as described herein. The dimensions include the chamber height (H), and in the example of a cylindrical air chamber, the chamber's diameter (D) which is twice the radius, such that a cylindrical air chamber's volume is:

$$V = {( π \times \frac{1}{2} D )}^{2} \times H .$$

The neck port, which is also a cylindrical tube in this example, has an area of

$${( π \times \frac{1}{2} W )}^{2}$$

and a length of L. The unit cell is not limited to cylindrical air chambers or cylindrical necks, but can be of any suitable shape that facilitates resonating at the desired frequency in a manner that phase cancels the incoming sound wave of that frequency.

The result is highly efficient sound absorption at specific frequencies as shown in FIG. 2B, which in this example is around 1310 Hz, making this metasurface particularly useful for targeted noise reduction in environments where controlling specific frequencies is beneficial, such as in architectural acoustics, automotive design, and industrial settings. The dimensions are deep subwavelength values relative to the subwavelength of the incoming wave. For example, one metasurface implementation was designed to inverse phase cancel an incoming frequency 1310 Hz, with selected unit-cell dimensions of D=18 mm, H=16 mm, L=6 mm, W=3.2 mm. The resulting absorption coefficient of the designed unit-cell achieved near-perfect (greater than 98 percent absorption at the designed frequency 1310 Hz), as shown in FIG. 2B. As can be seen from this example, the structure is deeply sub-wavelength; the wavelength λ at 1310 Hz in air is 260 mm, which is controlled by unit-cell with thickness of 22 mm. As can be seen, the above-selected dimensions of D, H, L and W for 1310 hertz (λ=260 m) in air range from about λ/14 to λ/81 (or λ/13 if based on the thickness of 22 mm). Note that while the curve of FIG. 2B shows about seventy percent absorption effectiveness around 1250 Hz increasing to the peak absorption at the desired frequency 1310 Hz, the curve can be flattened more around the designed frequency to an extent, e.g., by slightly tweaking the dimensions of some of the unit cells.

The designed unit-cell only needs air and its surrounding acoustic hard boundaries. This is different from other approaches using porous and fibrous materials and gradient index materials. At this scale the unit-cell acts almost like a point towards the wave, so this design is not straightforward. However, the materials and the compact design in mm-scale/deeply sub-wavelength facilitate fabricating the unit cell as a thin, light-weight, and cost effective absorber with 3D printing technology.

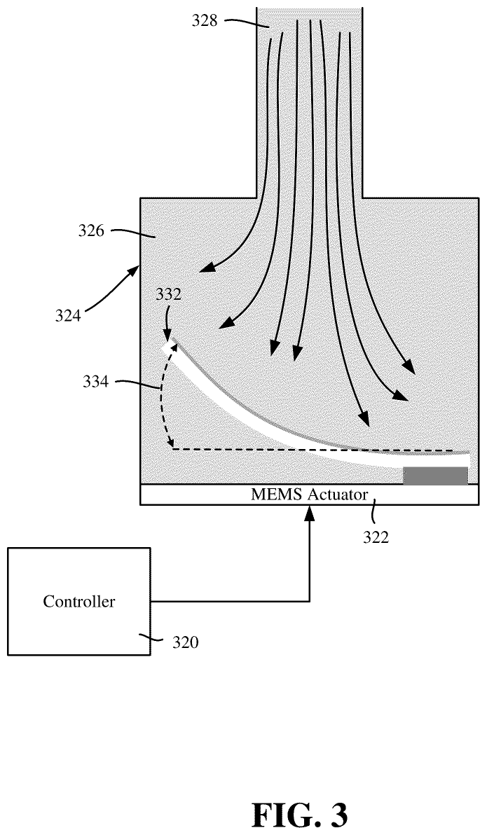

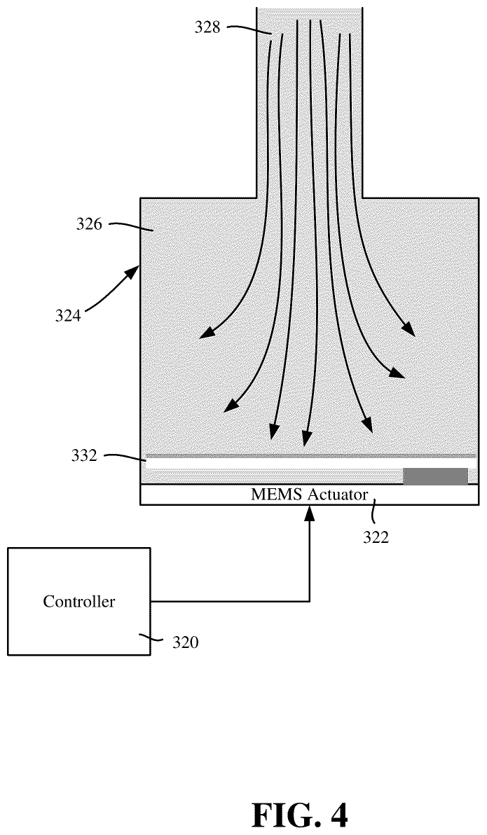

FIGS. 3 and 4 show the concept of a Helmholtz resonator 324 with variable resonance, which is based on a (e.g., bimorph) MEMS actuator (MA) 322, controlled by a controller 320. As shown in FIGS. 3 and 4, the example bimorph MEMS actuator (MA) 322 is in the form of a voltage-controlled bimorph cantilever 332 that is within the resonator's chamber 326, and thus is able to change the chamber's airflow based on the amount of displacement of the cantilever. Other types of MEMS actuators can be used instead, e.g., a lateral triple-arm device, and/or multiple MEMS actuators can work together to change the airflow.

In general, the bimorph MEMS actuator 322 changes the amount of cantilever displacement based on Joule heating, by applying a voltage across separated fixed (anchored) metallic ends of the cantilever 322, in which the metal (that is separated at the anchored end sides) is connected at the free end. The cantilever 322 thus can be in the shape of a penannular ring, U-shaped, V-shaped and so on, as long as voltage can be applied across the separated ends to heat the metal by current flow therethrough.

In the example of FIGS. 3 and 4, the arrows through the neck port 328 represent some incoming airflow (the outgoing airflow is not explicitly represented, but is understood to be based on the resonator's resonant frequency). Thus, the airflow can be varied by control of the amount of MEMS cantilever displacement, from a largest amount of upwards angle/curve as generally shown in FIG. 3, to a mostly flat angle (FIG. 4). The dashed, curved arrow 334 in FIG. 3 represents the range of cantilever tip displacement with respect to changing airflow.

By way of an example usage scenario, consider a metasurface of such unit cells configured to noise cancel the fan noise emanating from a server. The Helmholtz resonators' resonant frequency can be adjusted as described herein to significantly cancel the noise. Later, consider that the server fan changes its frequency as the server heats up/cools down, or that the server is replaced with a different server having a different fan noise frequency. Adjusting the bimorph MEMS actuators operates to cancel the different frequency instead.

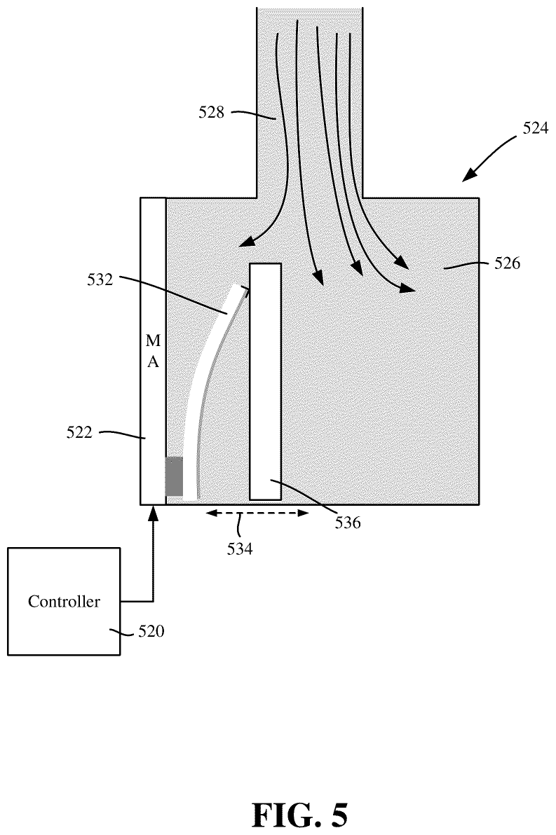

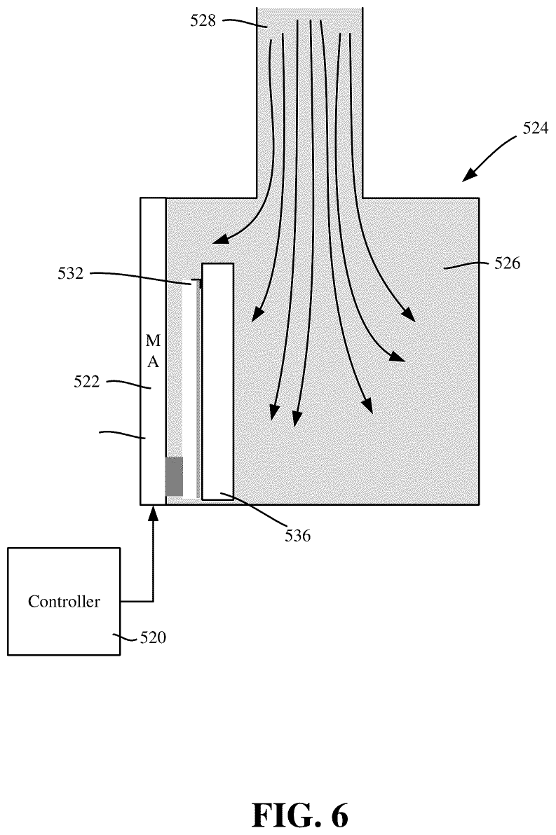

FIGS. 5 and 6 show the concept of a Helmholtz resonator 524 with variable resonance, which is similarly based on a (e.g., bimorph) MEMS actuator (MA) 522, controlled by a controller 520. As shown in FIGS. 5 and 6, the example bimorph MEMS actuator (MA) 522 is in the form of a cantilever 532 coupled to a moveable part 536 (e.g., a pillar) that is within the resonator's chamber 526, and thus is able to change the chamber's airflow based on the amount of displacement of the moveable part 536. Other types of MEMS actuators can be used instead, e.g., a lateral triple-arm device, and/or multiple MEMS actuators can work together to move the moveable part 536 to change the airflow. Although not shown, the moveable part can be angled and/or curved relative to the chamber floor, or bent/curved such that one part is straight and the other part is angled and/or curved, for example. Note that the moveable part can be constructed as part of the MEMS device, e.g., a MEMS device can be fabricated along with the moveable part as a single unit.

In the example of FIGS. 5 and 6, the arrows through the neck port 528 represent some incoming airflow (the outgoing airflow is not explicitly represented, but is understood to be based on the resonator's resonant frequency). In general, the airflow can be varied by control of the amount of MEMS cantilever displacement and corresponding movement of the moveable part 536, from a largest amount of angle/curve as generally shown in FIG. 5, to a mostly flat angle (FIG. 6). The dashed arrow 534 in FIG. 5 represents the range of the moveable part 536, based on the controlled amount of cantilever tip displacement, with respect to changing airflow.

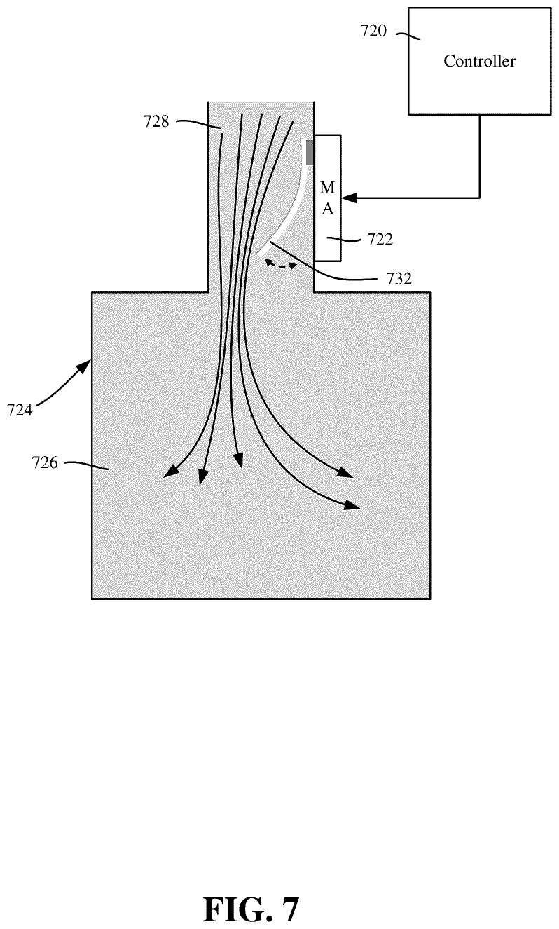

Instead of (or in addition to) having the MEMS device in the chamber to modify the airflow therein, the MEMS device can modify the airflow in the neck port. FIG. 7 shows a cantilever-type MEMS actuator 722 proximate to the neck port 728 of another resonator 724, in which the amount of displacement of the cantilever 732 is controlled by the controller 720 to change the airflow towards the chamber 726. Although not explicitly shown in FIG. 7, as is understood from FIGS. 4 and 6, the bimorph cantilever can straighten, e.g., with applied voltage; the dashed, curved arrow in FIG. 7 represents the range of cantilever tip displacement with respect to changing airflow in the neck port 728. Further, the MEMS device 722 can be wholly incorporated into the neck port 728.

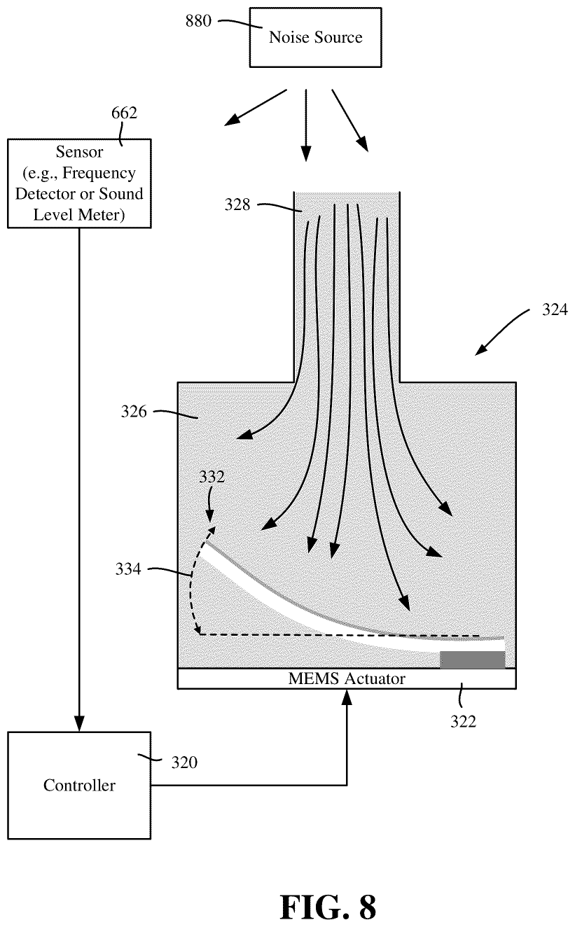

FIG. 8 shows the concept of feedback-based adjustment for noise cancellation, using the variable airflow resonator 324 of FIG. 3. In general, a noise source 880 such as one or more server fans outputs noise that can be sensed by a sensor 882. For example, a frequency sensor can pick up the main frequency peak of the noise, and communicate this information to the controller 320. The controller can then calculate (or look up/interpolate from previously determined data) the actuator voltage needed to change the airflow to cancel that frequency, and adjust the MEMS actuator 322/cantilever 332 accordingly. Another alternative is to sense the noise level, e.g., at some appropriate location or locations, and adjust the MEMS actuator 322/cantilever 332 until the lowest amount of noise level results. As the frequency of the acoustic wave (noise) changes, the MEMS actuators can be adjusted to cancel the changed frequency, which can be a reasonably rapid adjustment.

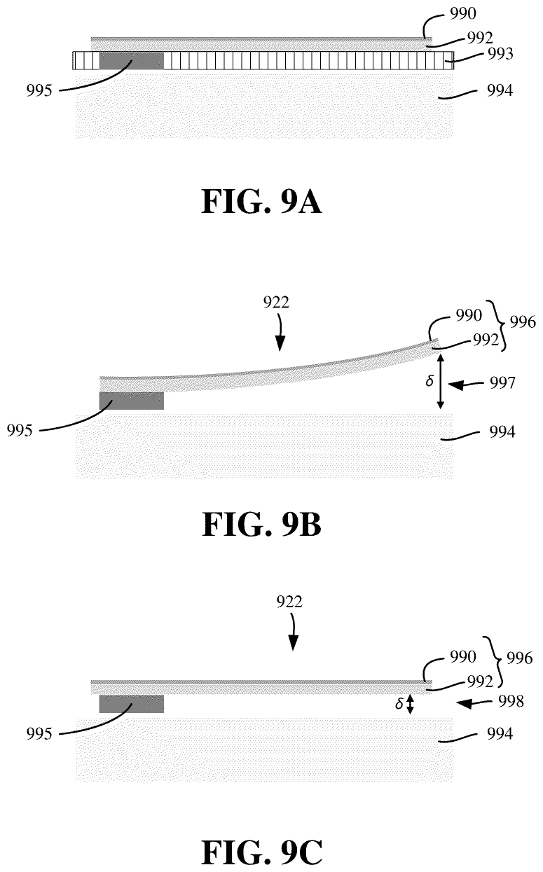

Turning to cantilever-based MEMS actuators, as shown in the fabrication cross-section representations in FIG. 9A-9C, a MEMS actuator 922 can be made from a bimorph material, such as a thin stack of aluminum (Al) 990, which is the bimorph top layer along with an aluminum oxide (Al2O3) layer 992. This facilitates efficient fabrication, as all metallic layers can be the same materials, and/or the same thicknesses. In the layer stack of FIG. 9A, going from top to bottom, the top bimorph layer (990 and 992) is on the top of a sacrificial layer 993 of silicon dioxide (SiO2), which sits on the bottom 994 of the metasurface supporting structure or the like. An anchor layer 995, at the same level as the sacrificial layer 993, can be aluminum or other suitable material. Note that while aluminum and/or aluminum oxide are suitable materials, any suitable bimorph material can be used.

The sacrificial layer 993 is selectively removed (e.g., by known etching methods) from underneath the top metal layers 990 and 992, resulting in a cantilever 996 by leaving an air gap 997 on one side of the cantilever 996 after release, as shown in FIG. 9B. The other side of the cantilever 996 remains attached to the bottom/side 994 of the metasurface supporting structure via the anchor 995 on one end. Note that due to residual stresses in the fabrication process, a bimorph cantilever is curved upwards in the absence of Joule heating, resulting in the air gap 997 as shown in FIG. 9B. The direction and/or magnitude of the bending depends on factors such as the nature and distribution of residual stress, as well as the dimensions and geometry of the cantilever.

Joule heating results in electrothermal actuation, which straightens the bimorph cantilever 996, as the free end of the heated cantilever 996 moves downward based on the amount of joule heating, as generally represented in FIG. 9C. In other words, when Joule heated, the bimorph actuator cantilever straightens out, e.g., to a straight cantilever, as shown in FIG. 9C. Note that the displacement δ decreases, as apparent from the smaller air gap 998 in the actuated state shown in FIG. 9C, relative to the non-actuated state in FIG. 9B. Although not explicitly shown, it is feasible to have a metallic cantilever that bends downward in response to joule heating, e.g., in an alternative implementation, the cantilever can be angled somewhat downward when non-actuated, and bent upward when subject to joule heating, which also changes the airflow/move a moveable part to change the airflow, in a resonator. FIG. 9C thus corresponds to one MEMS cantilever-type actuator in its actuated state, which shows the vertical displacement, δ, of the tip of the cantilever due to applied voltage/joule heating without any other external forces applied. The vertical displacement δ can be derived from the thermal expansion equation and the bending moment equation.

In another nonlimiting implementation, the top layer can be made from a metal (non-bimorph) material, such as aluminum (Al) and aluminum oxide (Al2O7). When the sacrificial layer is selectively removed from underneath the bimorph layer, a cantilever results by leaving an air gap on one side of the cantilever after release, with the other side of the cantilever remaining anchored. Unlike the bimorph cantilever, the single metal (e.g., aluminum) cantilever is straight and parallel in the absence of Joule heating, somewhat similar to the side view shown in FIG. 9C. When Joule heated, the metal actuator cantilever curves upward, similar to FIG. 9C. In any event, regardless of whether initially straight or curved when not actuated, Joule heating of a MEMS cantilever can vary the airflow in a Helmholtz resonator.

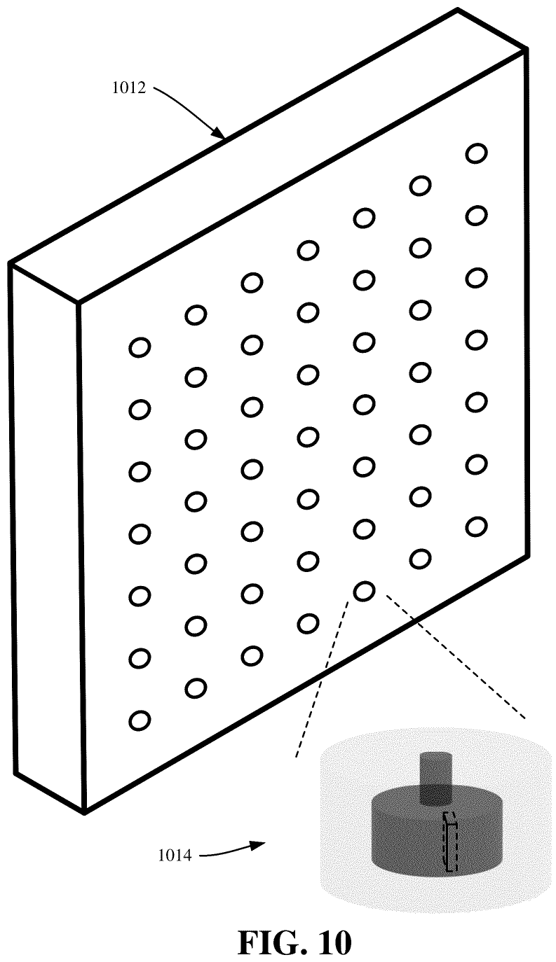

Some or all of the sound absorbing unit cells can be fabricated using 3D printing technology with the features of material simplicity and deeply sub-wavelength compact design. An illustration of an example metasurface 1012 with an arrayed distribution of variable volume unit-cells (one of which labeled 1014 is enlarged) is shown in FIG. 10.

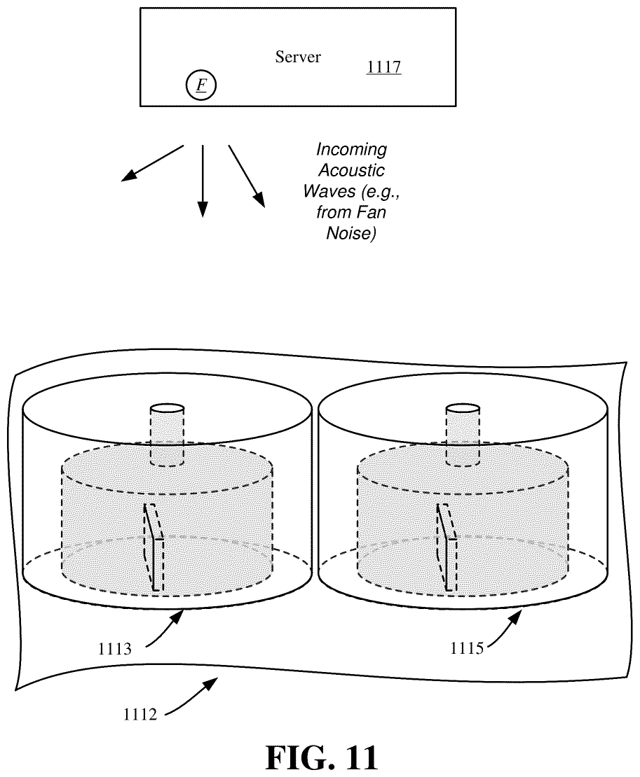

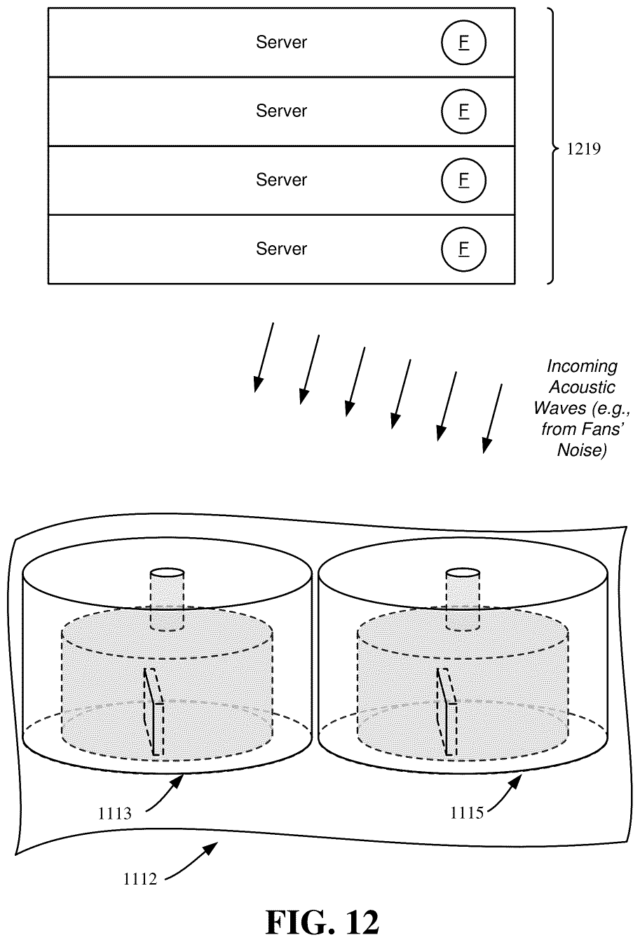

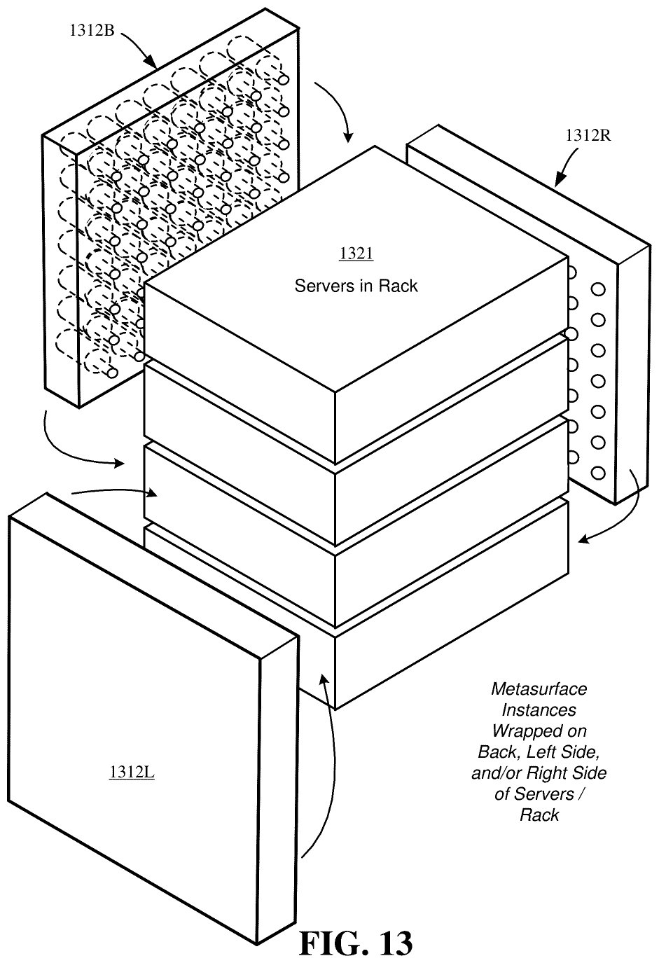

FIG. 11 depicts an example usage scenario, in which a portion of a metasurface 1112 is shown with two enlarged moveable-floor type unit cells 1113 and 1115 positioned proximate to a server 1117 to cancel noise emanating from the server's fan F. Although not explicitly shown herein, a metasurface or multiple metasurfaces as described herein can be positioned as a noise canceling device proximate a server 1117 (FIG. 11) or rack of servers 1219 (FIG. 12), and/or wrapped around at least part of a server or rack of servers 1321 (metasurfaces 1312B, 1312L and 1312R) as depicted in FIG. 13.

One or more aspects can be embodied in a system, such as described and represented in the drawing figures herein. The system can include a unit cell of a metasurface configured for sound absorption within a narrowband frequency range. The unit cell can include an air cavity within a support housing, the air cavity comprising a chamber and a neck port, and a bimorph microelectromechanical systems device that, in response to control signaling, changes airflow in the air cavity to determine a resonant frequency of the unit cell, to resonate the unit cell at the resonant frequency to phase cancel the incoming acoustic wave, responsive to being exposed to the incoming acoustic wave.

The control signaling can include a first amount of energy at a first time and a second amount of energy at a second time, and the bimorph microelectromechanical systems device can move from a first angle or curve, based on the first amount of energy, to a second angle or curve, based on the second amount of energy. The first amount of energy can correspond to a zero voltage, and the second amount of energy can correspond to a non-zero voltage.

The control signaling can include a first amount of energy at a first time and a second amount of energy at a second time, and the bimorph microelectromechanical systems device can include a moveable portion that moves from a first location, based on the first amount of energy, to a second location, based on the second amount of energy.

The microelectromechanical systems device can be positioned in the chamber.

The bimorph microelectromechanical systems device can be physically coupled to a moveable part within the air cavity, the control signaling can include a first amount of energy at a first time and a second amount of energy at a second time, and the bimorph microelectromechanical systems device can move the moveable part from a first location, based on the first amount of energy, to a second location, based on the second amount of energy. The moveable part can be positioned in the chamber. The moveable part can be positioned in the neck port. The moveable part can be angled or curved relative to the neck port.

The system of further can include a controller that outputs the control signaling as energy that heats the bimorph microelectromechanical systems device, to move a moveable portion of the bimorph microelectromechanical systems device by a controlled displacement distance corresponding to an amount of the energy.

The microelectromechanical systems device can include a bimorph cantilever comprising an anchored portion and a non-anchored portion, wherein the non-anchored portion can be at a first angle or curve relative to a second angle or curve of the non-anchored portion in a non-energized state, corresponding to a zero amount of energy output by the controller, as a result of residual stress, and, in an energized state, the non-anchored portion can be at a third angle or curve that can be different from the first angle or curve.

The unit cell can be incorporated into a metasurface comprising an array of unit cells.

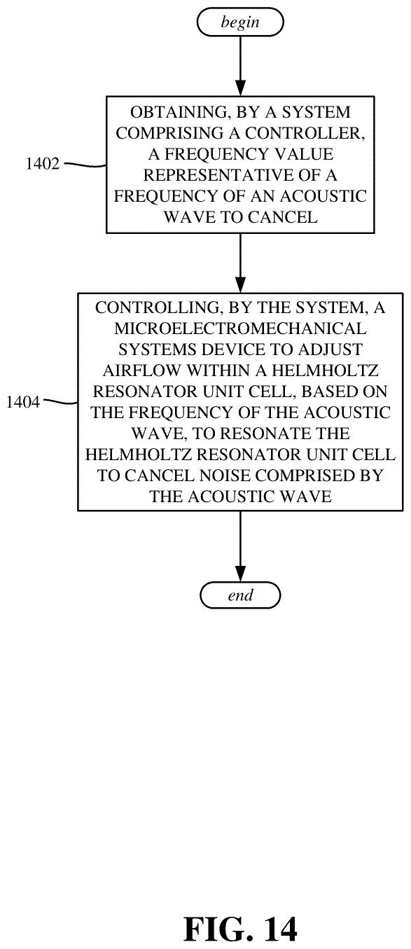

One or more example aspects, such as corresponding to example operations of a method, can be represented in FIG. 14. Example operation 1402 represents obtaining, by a system comprising a controller, a frequency value representative of a frequency of an acoustic wave to cancel. Example operation 1404 represents controlling, by the system, a microelectromechanical systems device to adjust airflow within a Helmholtz resonator unit cell, based on the frequency of the acoustic wave, to resonate the Helmholtz resonator unit cell to cancel noise can included by the acoustic wave.

Controlling the microelectromechanical systems device to adjust the airflow can include applying a voltage bias to the microelectromechanical systems device to at least one of: vertically or laterally move a moveable structure within the Helmholtz resonator unit cell by a displacement distance that corresponds to the voltage bias.

Controlling the microelectromechanical systems device to adjust the airflow can include applying a voltage bias to the microelectromechanical systems device to change an angle or curve of a moveable structure within the Helmholtz resonator unit cell, and wherein the angle or curve corresponds to the voltage bias.

One or more aspects can be embodied in a metasurface, such as described and represented in the drawing figures herein. The metasurface can include a base structure and a group of respective unit cells contained by the base structure. The respective unit cells can include respective Helmholtz resonators, which can include respective air chambers coupled to respective neck ports that extend to a surface of the base structure to facilitate air flow to the respective air chambers, and respective microelectromechanical systems devices that can be controllable to change respective airflow properties of the respective Helmholtz resonators The respective airflow properties can be adjustable, via the respective microelectromechanical systems devices, to resonate the respective unit cells at respective specific frequency values to collectively phase cancel an incoming acoustic wave responsive to being exposed to the incoming acoustic wave.

The respective unit cells can be evenly distributed in an array pattern within the base structure.

The respective unit cells can include respective neck ports and respective air chambers, and wherein the respective air chambers can include respective moveable parts, coupled to the microelectromechanical systems devices, that can be moveable to change the respective airflow properties of the air chambers.

The respective unit cells can include respective neck ports and respective air chambers, and wherein the respective neck ports can include respective moveable parts, coupled to the microelectromechanical systems devices, that can be moveable to change the respective airflow properties of the neck ports.

The metasurface can be configured to collectively phase cancel at least one incoming acoustic wave respectively emanating from at least one server.

As can be seen, the technology described herein facilitates construction and deployment of a metasurface of unit cells having variable airflow properties controlled via MEMS actuators, which can be implemented in a practical, compact and lightweight surface configuration. As one example, the metasurface is highly useful in the context of mitigating server noise. One unit-cell design achieved high sound absorption of an incoming sound wave at the frequency for which it was designed and MEMS-adjusted. Based on the technology described herein, thin, lightweight, and cost effective sound absorbers can be constructed, including by using 3D printing and MEMS technology.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a unit cell of a metasurface configured for sound absorption within a narrowband frequency range, the unit cell comprising:
an air cavity within a support housing, the air cavity comprising a chamber and a neck port; and
a bimorph microelectromechanical systems device that, in response to control signaling, changes airflow in the air cavity to determine a resonant frequency of the unit cell, to resonate the unit cell at the resonant frequency to phase cancel the incoming acoustic wave, responsive to being exposed to the incoming acoustic wave.

2. The system of claim 1, wherein the control signaling comprises a first amount of energy at a first time and a second amount of energy at a second time, and wherein the bimorph microelectromechanical systems device moves from a first angle or curve, based on the first amount of energy, to a second angle or curve, based on the second amount of energy.

3. The system of claim 2, wherein the first amount of energy corresponds to a zero voltage, and wherein the second amount of energy corresponds to a non-zero voltage.

4. The system of claim 1, wherein the control signaling comprises a first amount of energy at a first time and a second amount of energy at a second time, and wherein the bimorph microelectromechanical systems device comprises a moveable portion that moves from a first location, based on the first amount of energy, to a second location, based on the second amount of energy.

5. The system of claim 1, wherein the microelectromechanical systems device is positioned in the chamber.

6. The system of claim 1, wherein the bimorph microelectromechanical systems device is physically coupled to a moveable part within the air cavity, wherein the control signaling comprises a first amount of energy at a first time and a second amount of energy at a second time, and wherein the bimorph microelectromechanical systems device moves the moveable part from a first location, based on the first amount of energy, to a second location, based on the second amount of energy.

7. The system of claim 6, wherein the moveable part is positioned in the chamber.

8. The system of claim 6, wherein the moveable part is positioned in the neck port.

9. The system of claim 6, wherein the moveable part is angled or curved relative to the neck port.

10. The system of claim 1, further comprising a controller that outputs the control signaling as energy that heats the bimorph microelectromechanical systems device, to move a moveable portion of the bimorph microelectromechanical systems device by a controlled displacement distance corresponding to an amount of the energy.

11. The system of claim 1, wherein the microelectromechanical systems device comprises a bimorph cantilever comprising an anchored portion and a non-anchored portion, wherein the non-anchored portion is at a first angle or curve relative to a second angle or curve of the non-anchored portion in a non-energized state, corresponding to a zero amount of energy output by the controller, as a result of residual stress, and wherein, in an energized state, the non-anchored portion is at a third angle or curve that is different from the first angle or curve.

12. The system of claim 1, wherein the unit cell is incorporated into a metasurface comprising an array of unit cells.

13. A method, comprising:
obtaining, by a system comprising a controller, a frequency value representative of a frequency of an acoustic wave to cancel; and
controlling, by the system, a microelectromechanical systems device to adjust airflow within a Helmholtz resonator unit cell, based on the frequency of the acoustic wave, to resonate the Helmholtz resonator unit cell to cancel noise comprised by the acoustic wave.

14. The method of claim 13, wherein the controlling of the microelectromechanical systems device to adjust the airflow comprises applying a voltage bias to the microelectromechanical systems device to at least one of: vertically or laterally move a moveable structure within the Helmholtz resonator unit cell by a displacement distance that corresponds to the voltage bias.

15. The method of claim 13, wherein the controlling of the microelectromechanical systems device to adjust the airflow comprises applying a voltage bias to the microelectromechanical systems device to change an angle or curve of a moveable structure within the Helmholtz resonator unit cell, and wherein the angle or curve corresponds to the voltage bias.

16. A metasurface, comprising:
a base structure; and
a group of respective unit cells contained by the base structure,
wherein the respective unit cells comprise respective Helmholtz resonators comprising respective air chambers coupled to respective neck ports that extend to a surface of the base structure to facilitate air flow to the respective air chambers, and respective microelectromechanical systems devices that are controllable to change respective airflow properties of the respective Helmholtz resonators, and
wherein the respective airflow properties are adjustable, via the respective microelectromechanical systems devices, to resonate the respective unit cells at respective specific frequency values to collectively phase cancel an incoming acoustic wave responsive to being exposed to the incoming acoustic wave.

17. The metasurface of claim 16, wherein the respective unit cells are evenly distributed in an array pattern within the base structure.

18. The metasurface of claim 16, wherein the respective unit cells comprise respective neck ports and respective air chambers, and wherein the respective air chambers comprise respective moveable parts, coupled to the microelectromechanical systems devices, that are moveable to change the respective airflow properties of the air chambers.

19. The metasurface of claim 16, wherein the respective unit cells comprise respective neck ports and respective air chambers, and wherein the respective neck ports comprise respective moveable parts, coupled to the microelectromechanical systems devices, that are moveable to change the respective airflow properties of the neck ports.

20. The metasurface of claim 16, wherein the metasurface is configured to collectively phase cancel at least one incoming acoustic wave respectively emanating from at least one server.
